(19) United States
(12) Patent Application Publication
(10) Pub. No.: US 2013/0055103 A1
(43) Pub. Date: Feb. 28, 2013

(54) APPARATUS AND METHOD FOR CONTROLLING THREE-DIMENSIONAL GRAPHICAL USER INTERFACE (3D GUI)

(71) Applicants: Keun Sung CHOI, Seoul (KR); Sung Jin Kim, Seoul (KR)

(72) Inventors: Keun Sung CHOI, Seoul (KR); Sung Jin Kim, Seoul (KR)

(73) Assignee: PANTECH CO., LTD., Seoul (KR)

(21) Appl. No.: 13/594,023

(22) Filed: Aug. 24, 2012

(30) Foreign Application Priority Data
Aug. 29, 2011 (KR) 10-2011-0086536

(51) Int. Cl. G06F 3/01

(52) U.S. Cl. 715/740

(57) ABSTRACT

An apparatus to control a three dimensional graphical user interface (3D GUI) of a terminal, includes: a receiver to receive the position data communicated from a remote device; and an extractor to extract coordinates from the position data; wherein the position data allows the apparatus to control a 3D GUI based on the extracted coordinates. A system includes: a remote device, with a position sensor affixed to the remote device; a terminal to display the 3D GUI, with a communication unit to receive the sensed position data from the remote device; wherein the position data allows the terminal to control a 3D GUI based on the sensed position data. A method includes: sensing position data of a remote device relative to the terminal; communicating the sensed position data to the terminal; and controlling the 3D GUI based on the sensed position data.

### CROSS-REFERENCE TO RELATED APPLICATION

This application claims priority from and the benefit of Korean Patent Application No. 10-2011-0086536, filed on Aug. 29, 2011, which is hereby incorporated by reference for all purposes as if fully set forth herein.

### BACKGROUND

1. Field

Exemplary embodiments of the present invention relate to an apparatus and method for controlling a three-dimensional Graphical User Interface (3D GUI), and specifically, to an apparatus and method for controlling a 3D GUI of a terminal.

2. Discussion of the Background

Along with the development of personal portable mobile devices, such as mobile phones, portable computers, smartphones, and the like, user interfaces to control mobile devices are being developed.

Research has been directed to an interface to provide a three-dimensional Graphical User Interface (3D GUI). In a 3D GUI, a head tracking technology is utilized to track a position of a user's face using a front-facing camera attached on a front surface of a terminal, and the like, and to change and control a 3D GUI based on the position of the user's face. In the head tracking technology, a camera placed on a front surface of a mobile device may show a 3D stereoscopic image based on a movement of a user's head, while directly tracking the movement of the user's head. If the head moves up, down, left and right, different images may be displayed in real-time based on a distance and angle between the camera and the head, and the user's eyes may recognize the different images as 3D stereoscopic images.

In another implementation of 3D GUI, an infrared sensor is used. The infrared sensor may be mounted in a main body of a television (TV), may be similar to a sensor used to receive a signal from a TV remote control, and may respond to light in a specific infrared wavelength in the vicinity of the infrared sensor. If a user's head moves, the head being affixed to two infrared lamps, positions of the two infrared lamps may be tracked and computed, and the computed positions may be transmitted to an output device. Here, the two infrared lamps may calculate a 3D position based on up, down, left and right directions, and a slope. Subsequently, a physical engine for movement, that is, an acceleration and inertia may be processed using computer software or hardware, and a is result of the processing may be displayed on a display. Through the above process, an image displayed on the display may be viewed as a 3D landscape through a window (or on a monitor), due to a change in a view based on a movement of a user, rather than being viewed in a single fixed view based on the laws of perspective. In other words, the technology enables a two-dimensional (2D) image to be viewed as if the 2D image is in 3D, rather than implementing a 3D hologram.

However, these 3D GUIs have problems. For example, if a camera is used, and a distance between the camera and a user increases, it may be difficult to recognize a movement of the user. Additionally, if a face of another user appears in front of the camera, it may be difficult for the camera to track the original user's face. In the example using an infrared sensor, an additional infrared receiving device may be provided.

### SUMMARY

Exemplary embodiments of the present invention provide an apparatus and method for controlling a three-dimensional Graphical User Interface (3D GUI), and specifically, to an apparatus and method for controlling a 3D GUI of a terminal.

Additional features of the invention will be set forth in the description which follows, and in part will be apparent from the description, or may be learned by practice of the invention.

An exemplary embodiment of the present invention discloses an apparatus to control a three dimensional graphical user interface (3D GUI) of a terminal, including: a receiver to receive the position data communicated from a remote device; and an is extractor to extract coordinates from the position data; wherein the position data allows the apparatus to control a 3D GUI based on the extracted coordinates.

An exemplary embodiment of the present invention discloses a system to control a three dimensional graphical user interface (3D GUI), including: a remote device, with a position sensor affixed to the remote device, to sense position data of the remote device; a terminal to display the 3D GUI, with a communication unit to receive the sensed position data from the remote device; wherein the position data allows the terminal to control a 3D GUI based on the sensed position data.

An exemplary embodiment of the present invention discloses a method for controlling a three dimensional graphical user interface (3D GUI) of a terminal, including: sensing position data of a remote device relative to the terminal; communicating the sensed position data to the terminal; and controlling the 3D GUI based on the sensed position data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a headphone, and a terminal according to is an exemplary embodiment of the present invention.

FIG. 2 is a diagram illustrating a configuration of a three-dimensional Graphical User Interface (3D GUI) control apparatus according to an exemplary embodiment of the present invention.

FIG. 3 is a diagram illustrating a headphone and a terminal, according to an exemplary embodiment of the present invention.

FIG. 4 is a diagram illustrating data of a Human Interface Device (HID) profile format according to an exemplary embodiment of the present invention.

FIG. 5 is a flowchart illustrating a method for controlling a 3D GUI according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may is be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one is of X, Y, and Z” can be construed as X only, Y only, Z only, or any combination of two or more items X, Y, and Z (e.g., XYZ, XYY, YZ, ZZ).

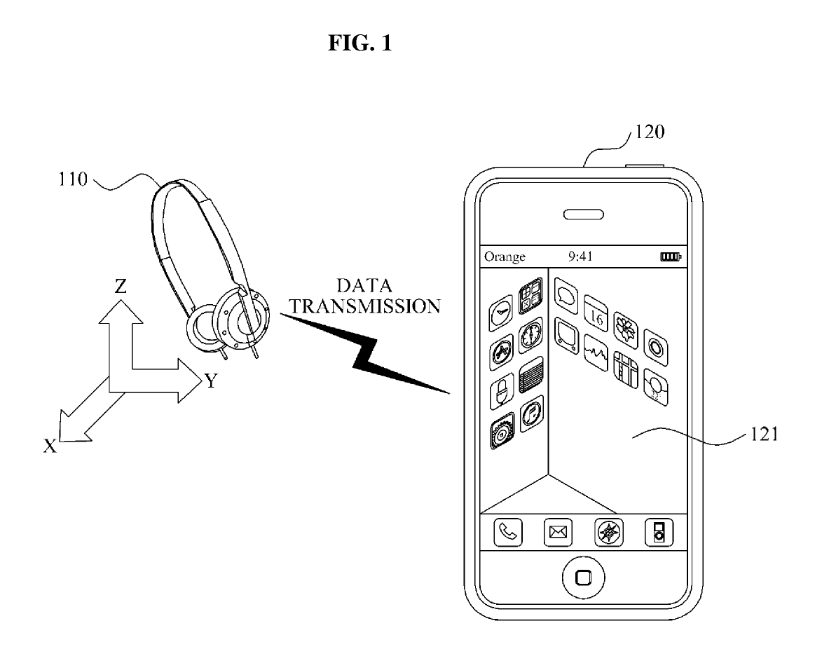

FIG. 1 is a diagram illustrating a headphone, and a terminal according to an exemplary embodiment of the present invention.

Referring to FIG. 1, the terminal 120 may provide a three-dimensional Graphical User Interface (3D GUI) 121. The terminal 120 may compute a position of a user's face, may change the 3D GUI 121 based on the computed position, and may display the changed 3D GUI 121 on the terminal 120. The display may be updated dynamically along with the movement of the user's face.

To compute the position of the user's face, the terminal 120 may compute a position of the headphone 110 used by the user. In doing so, the terminal 120 may determine that the computed position of the headphone 110 corresponds to the position of the user's face.

The headphone 110 may be a Bluetooth enabled device. The headphone 110 may communicate with the terminal 120 by a short range communication technique, such as a radio frequency (RF) technique or the like.

Although a headphone 110 is described in many of the examples of this disclosure, one of ordinary skill in the art will appreciate that other devices, such as a pair of 3D glasses or a mouse or other physical object capable of data transmission with the terminal may also be used.

If the position of the user's face is determined according to a change in the position of the headphone 110, the terminal 120 may change and control the 3D GUI 121, based on a change in a user's eyes caused by a change in the position of the user's face. Thus, a detected position change may occur due to the headphone 110 being moved, while the control of the 3D GUI 121 may be accomplished with a movement or change in a user's eyes. In this way, a 3D GUI 121 may be controlled by both a movement in a headphone 110 and the movement of a user associated feature, such as the user's eyes.

An operation by which the terminal 120 controls the 3D GUI 121 may be performed by a 3D GUI control apparatus that is inserted as a module into the terminal 120.

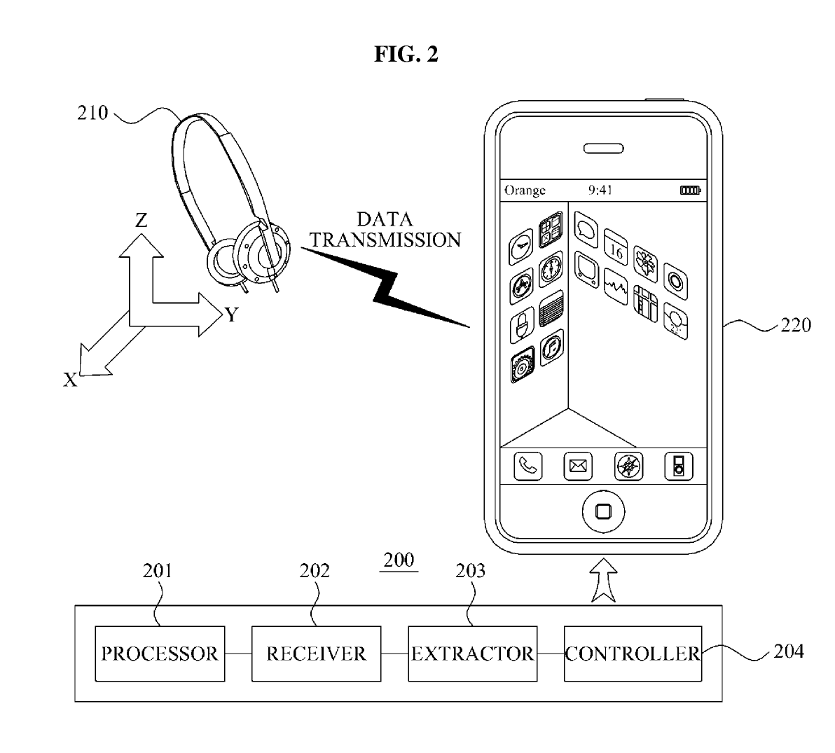

FIG. 2 is a diagram illustrating a configuration of a three-dimensional Graphical User Interface (3D GUI) control apparatus according to an exemplary embodiment of the present invention.

Referring to FIG. 2, the 3D GUI control apparatus 200 may include a processor 201, a receiver 202, an extractor 203, and a controller 204.

The processor 201 may set an initial position of a headphone 210, and an initial position of a terminal 220. Thus, if a user enables a 3D GUI capability of the terminal 220, the processor 201 may display, on the terminal 220, a message to instruct a user on how to set the initial position of the terminal 220. For example, the processor 201 may display, on the terminal 220, a guidance message stating that ‘Please stretch out your arms while carrying your phone with your hand, then look at the front of your phone, and maintain your face at a distance of about 30 cm between your phone and your face for 5 seconds.’ If the user maintains a position of the user for a specific period of time, without changing the position of the terminal 220 and the position of the headphone 210, the processor 201 may detect the initial position of the terminal 220, and the initial position of the headphone 210, and may store the detected initial positions.

The processor 201 may also use initial position information set in advance or provided in another way. Accordingly, the user may use the 3D GUI capability without having to set an initial position information before every use or before a first use.

The headphone 210 may include a sensor that is used to detect the position of the headphone 210. The sensor may be any sensor for detecting position, such as, an acceleration sensor, a geomagnetic sensor, and the like. The headphone 210 may detect the position of the headphone 210 by using the sensor (which may be built-in to the headphone), and may transmit to the terminal 220 position information regarding the detected position of the headphone 210 (hereinafter, referred to as ‘position information of the headphone 210’). Specifically, the headphone 210 may convert the position information of the headphone 210 to data of a Human Interface Device (HID) profile format, and may transmit the converted data to the terminal 220. The headphone 210 may transmit the position information using a HID profile. The HID profile may be used to transfer position coordinates of an input device, such as a mouse, and the like.

The receiver 202 may receive, from the headphone 210, the data in HID profile format. The data may include the position information. The received position information of the headphone 210 may be used to set an initial position of the headphone 210.

The extractor 203 may extract the position information of the headphone 210 from the data of the HID profile format. The HID profile may include coordinates of the headphone 210 to populate the various data fields of a HID profile. Additionally, the position of the headphone 210 may be represented by coordinates of a Cartesian coordinate system, or coordinates of a spherical coordinate system.

The controller 204 may control a 3D GUI of the terminal 220, based on the initial position of the headphone 210, and current position information of the headphone 210. The controller 204 may calculate a changed value between the initial position of the headphone 210 and a current position of the headphone 210, and may control the 3D GUI based on the calculated change value. For example, when a change value between the initial position of the headphone 210 and the position of the headphone 210 is calculated to be a positive value of ‘Y,’ the controller 204 may determine that the user's face has moved in a Y-axis direction, namely upward, and may change the 3D GUI based on a movement of the user's face. This change may be displayed.

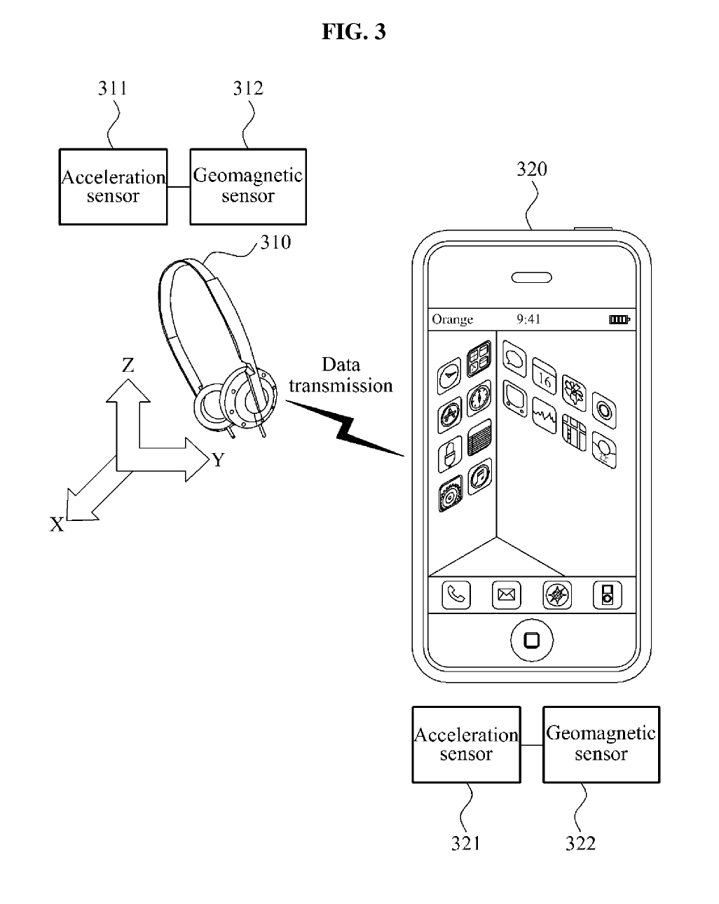

FIG. 3 is a diagram illustrating a headphone and a terminal, according to an exemplary embodiment of the present invention. FIG. 3 will be described as if the terminal 320 includes the 3D GUI control apparatus 200 of FIG. 2, but is not limited as such.

Referring to FIG. 3, the headphone 310 may include an acceleration sensor 311, and a geomagnetic sensor 312.

The acceleration sensor 311 may be used to measure a displacement of the headphone 310 by recognizing acceleration detected in a corresponding direction. The acceleration sensor 311 may use the laws of gravity as a reference. For example, the acceleration sensor 311 may include a pedometer used to recognize people's walking pattern and to detect a movement of a position. Additionally, the acceleration sensor 311 may be used to detect a gravitational acceleration, or an inertial acceleration. The gravitational acceleration may have a static value due to gravity, and the inertial acceleration may have a dynamic value due to a movement of a detected target. The is acceleration sensor 311 may be used to measure a movement of the headphone 310 using an inertial acceleration for the movement, based on the detected gravitational acceleration.

The geomagnetic sensor 312 may be used to detect a direction of the headphone 310. The geomagnetic sensor 312 may be used to detect a current direction, for example, east, west, north, or south. The geomagnetic sensor 312 may include a compass. Additionally, the geomagnetic sensor 312 may include a 3-axis geomagnetic sensor to detect a vertical position, as well as the direction of the gravity.

The headphone 310 may measure an acceleration coordinate of the headphone 310 using the acceleration sensor 311, and may measure a geomagnetic coordinate of the headphone 310 using the geomagnetic sensor 312. Additionally, the headphone 310 may record, in each field of data of an HID profile format, the measured acceleration coordinate and the measured geomagnetic coordinate as position information of the headphone 310.

The terminal 320 of FIG. 3 may include an acceleration sensor 321, and a geomagnetic sensor 322.

The terminal 320 may measure an acceleration coordinate of the terminal 320 using the acceleration sensor 321, and may measure a geomagnetic coordinate of the terminal 320 using the geomagnetic sensor 322. Additionally, a receiver of a 3D GUI control apparatus 200 may receive, from the terminal 320, the measured acceleration coordinate and the measured geomagnetic coordinate. Here, a controller 204 of the 3D GUI control apparatus 200 may control a 3D GUI of the terminal 320, based on an initial position of the headphone 310, position information of the headphone 310, an initial is position of the terminal 320, the acceleration coordinate of the terminal 320, and the geomagnetic coordinate of the terminal 320.

The controller 204 may calculate a position change value of the headphone 310 based on the initial position of the headphone 310 and the position information of the headphone 310. Additionally, the controller 204 may calculate a position change value of the terminal 320 based on the initial position of the terminal 320, the acceleration coordinate of the terminal 320 and the geomagnetic coordinate of the terminal 320. Furthermore, the controller 204 may compute a position of a face of a user of the terminal 320, based on the calculated position change values. The controller 204 may control the 3D GUI of the terminal 320 based on the computed position. The controller 204 may change a display state of the 3D GUI based on the position of the face. For example, the user may change at least one of a display angle and a display direction of the 3D GUI based on the position of the face, and may display the changed 3D GUI on the terminal 320.

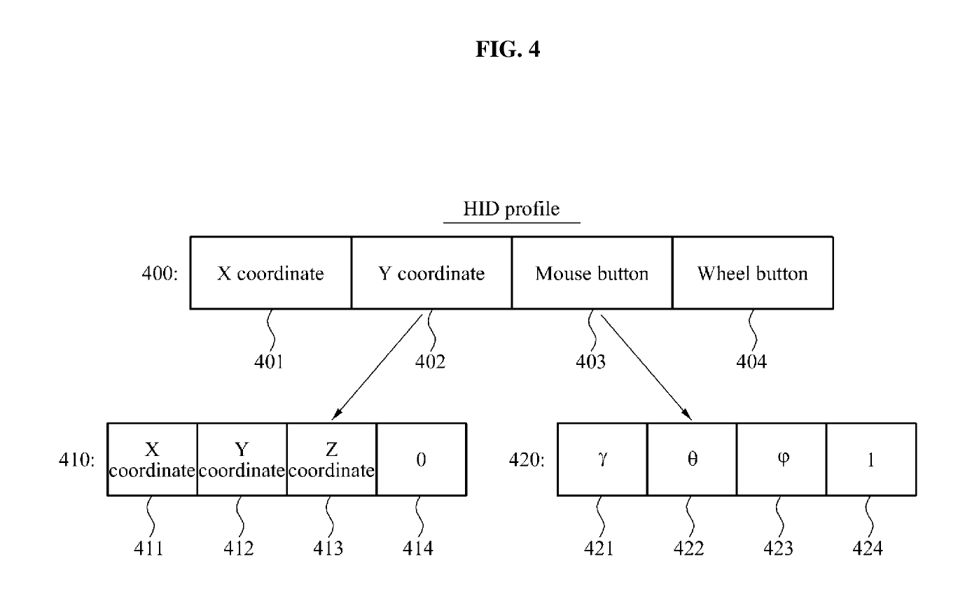

FIG. 4 is a diagram illustrating data of a Human Interface Device (HID) profile format according to an exemplary embodiment of the present invention.

Referring to FIG. 4, a HID profile 400 may be divided into various fields, such as data fields 401, 402, 403, and 404. The data fields 401, 402, 403, and 404 may correspond to an X coordinate, a Y coordinate, a mouse button value, and a wheel button value, respectively, among two-dimensional (2D) coordinates indicating a position of a mouse. Alternative to a mouse, the device may be any device used in conjunction with a 3D display, such a bluetooth headphone set, and the like.

A headphone may convert position information of the headphone to data is of an HID profile format, and may transmit the data to a terminal. The headphone may record an X coordinate, a Y coordinate, and a Z coordinate of the headphone in the data fields 401, 402, and 403, respectively.

The position information of the headphone may be represented by coordinates of the Cartesian coordinate system, or by coordinates of the spherical coordinate system. Accordingly, to control the 3D GUI, the terminal may identify which coordinate system is used to represent the position information of the headphone that is extracted from the data of the HID profile format.

The headphone may record, in the data field 404, a value indicating a type of a coordinate system of the position information of the headphone. For example, if a value of ‘0’ is recorded in the data field 404, the terminal may determine that coordinates are recorded using a Cartesian coordinate system in the data of the HID profile format. If a value of ‘1’ is recorded in the data field 404, the terminal may determine that coordinates are recorded using a spherical coordinate system in the data of the HID profile format.

For example, if data 410 is received from the headphone, the terminal may extract a value recorded in a data field 414 corresponding to a wheel button value, and may determine that coordinates of the Cartesian coordinate system are recorded in data fields 411, 412, and 413, since a value of ‘0’ is extracted. If data 420 is received from the headphone, the terminal may extract a value recorded in a data field 424 corresponding to a wheel button value, and may determine that coordinates of the spherical coordinate system are recorded in data fields 421, 422, and 423, since a value of ‘1’ is extracted.

In the above example, the setting of whether to use a Cartesian coordinate is system or a spherical coordinate system is determined by a wheel button value. However, one of ordinary skill in the art is not limited to such an implemented, and may utilize any sort of technique for toggling between a 1 and 0.

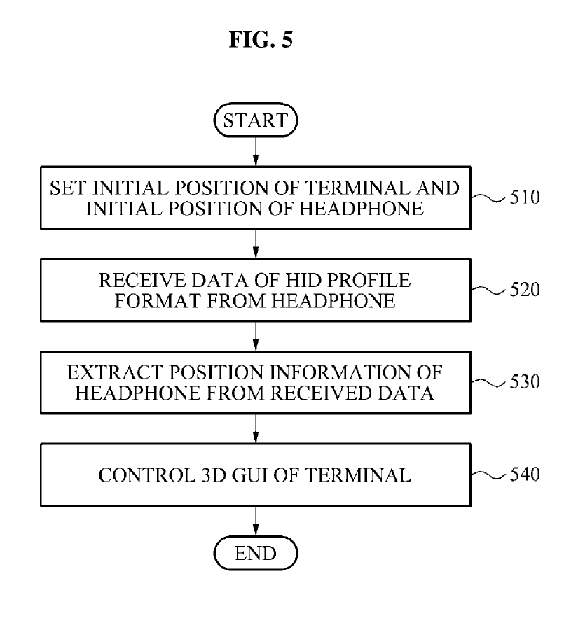

FIG. 5 is a flowchart illustrating a method for controlling a 3D GUI according to an exemplary embodiment of the present invention.

Referring to FIG. 5, in operation 510, an initial position of a headphone, and an initial position of a terminal may be set. If a user enables a 3D GUI capability of the terminal, a message instructing the user to set the initial position of the terminal may be displayed on the terminal. For example, a message stating ‘Please stretch out your arms while carrying your phone with your hand, then look at the front of your phone, and keep your face at a distance of about 30 cm between your phone and your face for 5 seconds’ may be displayed on the terminal. If the user maintains a position for a reference period of time, without changing the position of the terminal and the position of the headphone, the initial position of the terminal, and the initial position of the headphone may be detected and stored.

As explained above, an initial position information that is set in advance may be used. Accordingly, the user may use the 3D GUI capabilities without setting an initial position information every time.

The headphone may include a sensor used to detect its position. The sensor may be any sensor for detecting position, such as, an acceleration sensor, a geomagnetic sensor, and the like. The headphone may detect its position using a sensor (that may be built-in), and may transmit, to the terminal, position information regarding the detected position of the headphone. Specifically, the headphone may convert the is position information of the headphone to data of an HID profile format, and may transmit the converted data to the terminal. The headphone may transmit its position information using the HID profile format. The HID profile may be used to transfer position coordinates of an input device, such as a mouse, and the like.

In operation 520, the data of the HID profile format may be received from the headphone. Here, the data of the HID profile format may include the position information of the headphone. The received position information of the headphone may be used to set an initial position of the headphone.

In operation 530, the position information of the headphone may be extracted from the data of the HID profile format. The HID profile may include coordinates of the headphone for each data field of the HID profile. Additionally, the position of the headphone may be represented by coordinates of a Cartesian coordinate system, or coordinates of a spherical coordinate system.

In operation 540, a 3D GUI of the terminal may be controlled based on the initial position of the headphone, and the position information of the headphone. A change value between the initial position of the headphone and the position of the headphone corresponding to the received position information may be calculated, and the 3D GUI may be controlled based on the calculated change value. For example, if a change value between the initial position of the headphone and the position of the headphone is calculated to be a positive value of ‘Y,’ the user's face may be determined to be moved in a Y-axis direction, namely upward, and the 3D GUI may be changed and displayed based on a movement of the user's face. In order to track the relative position of the headphone with respect to the terminal, a coordinate initialization process may be performed. To initiate the coordinate initialization process, the terminal may output initialization request information, such as a voice or message, notifying the user to locate the headphone in an initialization position if the 3D functionality is enabled. For example, the terminal may output a voice signal requesting the user to locate the terminal apart from the headphone at a determined distance for a certain time period, e.g., maintaining about 30 cm between the headphone and the terminal for at least 5 seconds. The main display of the terminal may be oriented to face the headphone in the coordinate initialization process. If the initial locations of the terminal and the headphone are set, the terminal may set an initial location of the headphone with respect to the terminal, and an initial coordinate of the headphone may be set. After the coordinate initialization process, the terminal may track and calculate a movement of the terminal based on a movement sensor, such as an acceleration sensor, a geomagnetic sensor, and/or a gyroscope sensor, and update the relative location of the headphone with respect to the terminal based on the movement of the terminal. Further, the headphone may track and calculate a movement of the headphone based on a movement sensor, such as an acceleration sensor, a geomagnetic sensor, and/or a gyroscope sensor, and transmit information on the movement of the headphone to the terminal. The terminal may receive the information on the movement of the headphone and update the relative location of the headphone with respect to the terminal based on the information on the movement of the headphone. The movement information on the terminal or the headphone may include direction information and distance information. In other words, each of the headphone and the terminal may calculate its relative movement, and the terminal may update the relative location of the headphone with respect to the terminal is based on the movement of the terminal and/or the movement of the headphone. The information on the movement of the headphone may include a geomagnetic coordinate A1(x,y,z) calculated by a geomagnetic sensor and/or an acceleration coordinate A2(x,y,z) calculated by an acceleration sensor, and information on the movement of the terminal may include a geomagnetic coordinate B1(x,y,z) calculated by a geomagnetic sensor and/or an acceleration coordinate B2(x,y,z) calculated by an acceleration sensor, for example. The relative location between the terminal and the headphone may be updated based on the coordinates A1(x,y,z), A2(x,y,z), B1(x,y,z), and B2(x,y,z).

3D Surround Sound:

In addition to implementing the concepts of this disclosure to 3D video and 3D GUI, the concepts may also be applied to 3D sound. A sound player may play a recorded sound in a static way, thus not changing the sound based on a position or reference point. However, based on the dynamically provided position information as describe above, the location of a user may be determined to a sound-producing source such as a terminal. Thus, the sound producing source may modify the sound based on a movement of a user.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of is non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to control a three dimensional graphical user interface (3D GUI) of a terminal, comprising:
a receiver to receive the position data communicated from a remote device; and
an extractor to extract coordinates from the position data;
wherein the position data allows the apparatus to control a 3D GUI based on the extracted coordinates.

2. The apparatus according to claim 1, wherein the position sensor is one of, or a combination of: an acceleration sensor, or geomagnetic sensor.

3. The apparatus according to claim 1, wherein the remote device is a headset.

4. The apparatus according to claim 1, wherein the position data is in a Human Interface Device (HID) profile format.

5. The apparatus according to claim 1, wherein the position data contains a field to switch between various coordinate systems.

6. The apparatus according to claim 5, wherein the position data is stored as Cartesian coordinates.

7. The apparatus according to claim 5, wherein the position data is stored as spherical coordinates.

8. A system to control a three dimensional graphical user interface (3D GUI), comprising:
a remote device, comprising:
a position sensor affixed to the remote device, to sense position data of the remote device;
a terminal to display the 3D GUI, comprising:
a communication unit to receive the sensed position data from the remote device;
wherein the position data allows the terminal to control a 3D GUI based on the sensed position data.

9. The system according to claim 8, wherein the position sensor is one of, or a combination of: an acceleration sensor, or geomagnetic sensor.

10. The system according to claim 8, wherein the remote device is a headset.

11. The system according to claim 8, wherein the position data is in a Human Interface Device (HID) profile format.

12. The system according to claim 11, wherein the position data contains a field to switch between various coordinate systems.

13. The system according to claim 12, wherein the position data is stored as Cartesian coordinates.

14. The system according to claim 12, wherein the position data is stored as spherical coordinates.

15. A method for controlling a three dimensional graphical user interface (3D GUI) of a terminal, comprising:
sensing position data of a remote device relative to the terminal;
communicating the sensed position data to the terminal; and
controlling the 3D GUI based on the sensed position data.

16. The method according to claim 15, wherein the sensed position data is in a Human Interface Device (HID) profile format.

17. The method according to claim 15, wherein the sensed position data comprises a field identifying a coordinate system of the sensed position data.

18. The method according to claim 17, wherein the sensed position data is stored as Cartesian coordinates.

19. The method according to claim 17, wherein the sensed position data is stored as spherical coordinates.

20. The method according to claim 15, wherein controlling the 3D GUI further comprises controlling the 3D GUI based on a difference between an initial position of the remote device relative to the terminal and the sensed position data.
